(19) United States
(12) Patent Application Publication
(10) Pub. No.: US 2022/0138021 A1
(43) Pub. Date: May 5, 2022

(54) COMMUNICATIONS FOR WORKLOADS

(71) Applicant: Intel Corporation, Santa Clara, CA (US)

(72) Inventors: Todd RIMMER, Exton, PA (US); Mark DEBBAGE, Santa Clara, CA (US)

(21) Appl. No.: 17/561,903

(22) Filed: Dec. 24, 2021

Related U.S. Application Data
(60) Provisional application No. 63/225,343, filed on Jul. 23, 2021.

(51) Int. Cl. G06F 9/50; G06F 15/173

(52) U.S. Cl. CPC G06F 9/5083; G06F 15/17331; G06F 9/505; G06F 9/5044

(57) ABSTRACT

Examples described herein relate to a sender process having a capability to select from use of a plurality of connections to at least one target process, wherein the plurality of connections to at least one target process comprise a connection for the sender process and/or one or more connections allocated per job. In some examples, the connection for the sender process comprises a datagram transport for message transfers. In some examples, the one or more connections allocated per job utilize a kernel bypass datagram transport for message transfers. In some examples, the one or more connections allocated per job comprise a connection oriented transport and wherein multiple remote direct memory access (RDMA) write operations for a plurality of processes are to be multiplexed using the connection oriented transport.

### RELATED APPLICATION

The present application claims the benefit of priority of U.S. Provisional application Ser. No. 63/225,343, filed Jul. 23, 2021. The contents of that application are incorporated herein in its entirety.

### BACKGROUND

Remote Direct Memory Access (RDMA) Over Converged Ethernet (RoCE) Reliable Connected (RC) queue pairs (QPs) can be used for transfer of messages in artificial intelligence (AI) training and Message Passing Interface (MPI) applications. RoCE QPs can allow for communication of processes and sending data in user space whereby each process has its own QP and each process communicate separately using their own QPs. However, an approach using an RC QP between each pair of remote processes requires allocation of significant memory and QP resources.

### BRIEF DESCRIPTION OF THE DRAWINGS

FIGS. 1A and 1B depict example operations.

FIG. 2 depicts an example system.

FIG. 3 depicts an example system.

FIG. 4 depicts an example system.

FIG. 5 depicts an example process.

FIG. 6 depicts an example network interface.

FIG. 7 depicts an example computing system.

### DETAILED DESCRIPTION

In order to use RDMA as a point-to-point connection with MPI, a QP connection is to be established. MPI permits a process to communicate with another process in a job. A job with N nodes and P processes per node (e.g., 1 process per central processing unit (CPU) core) establishes N*P remote connections. For a node which has P processes, this is N*P² connections. Having N*P RC QPs per process and N*P² QPs per node can rapidly strain the memory resources on the node as well as stress network interface controller (NIC) QP resources and caches.

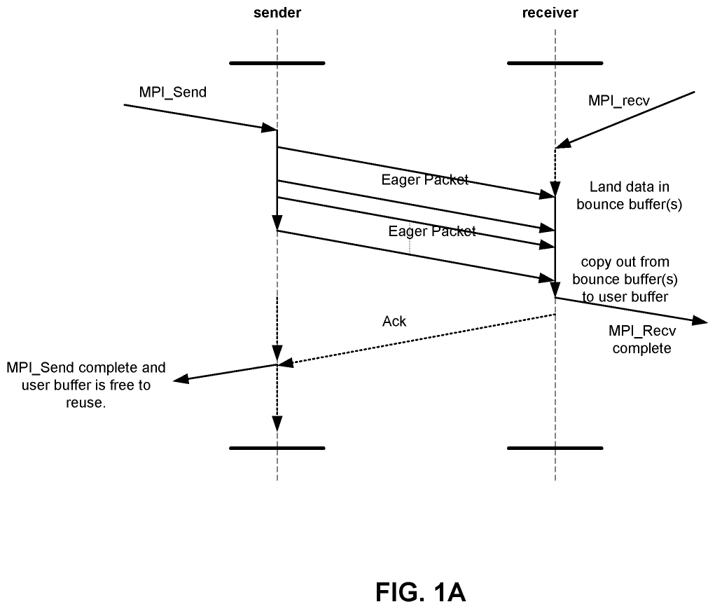

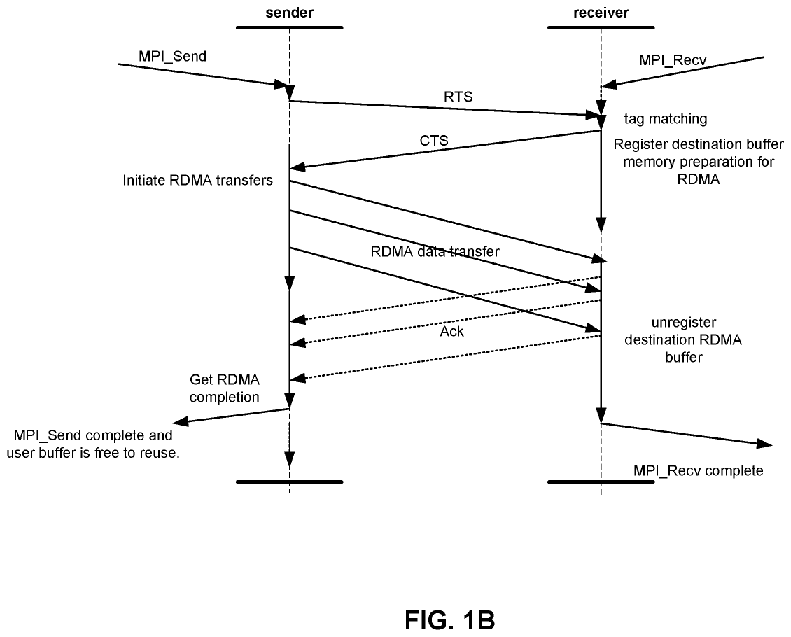

FIGS. 1A and 1B depict example operations involving MPI applications for respective eager and rendezvous messages. Eager messages may not have an allocated receiver buffer to receive messages whereas rendezvous messages can have an allocated receiver buffer to receive communications. FIG. 1A depicts an example of eager communications where a sender sends a message before a receiver indicates a buffer is available to store the message. At the sender, the receiver can store the unexpected message in a bounce buffer and then indicate acknowledgement of receipt of the message.

FIG. 1B depicts an example of rendezvous communications. Based on an MPI Send call, the sender sends a Request to Send (RTS) control message to a receiver. The receiver can compare the RTS against its expected queue, and if there is no match, the RTS is written to a queue designated for unexpected messages. In response to matching of the message, the receiver can issue a Clear to Send (CTS) to the sender. The CTS can include a remote key (rkey) and remote direct memory access (RDMA) addresses for an application buffer. In response to receipt of the CTS, the sender may perform RDMA Writes directly to the application buffer. Alternatively, the CTS could be an RDMA Read operation. For example, at 1000 node scale with 100 processes per node, this approach utilizes 10,000,000 RC queue pairs (QPs) and tens to hundreds of gigabytes of memory for QP state, Work Queue Entries (WQEs), receive buffers, and so forth.

InfiniBand and Intel Omni-Path Architecture (Intel OPA) solutions utilize a software Memory Registration cache to store rendezvous messages. As buffers are used for rendezvous messages, their addresses and memory regions (MRs) are retained. For rendezvous messages, the sender RDMA buffers and receiver RDMA buffers are to be registered as MRs. Registration can involve kernel calls, resolving virtual to physical address translations, locking pages into memory, building network interface device page tables in its MR memory management unit (MMU), mapping pages in the input-output memory management unit (IOMMU), handling page faulting, updating MR tables cached in the network interface device, and so forth.

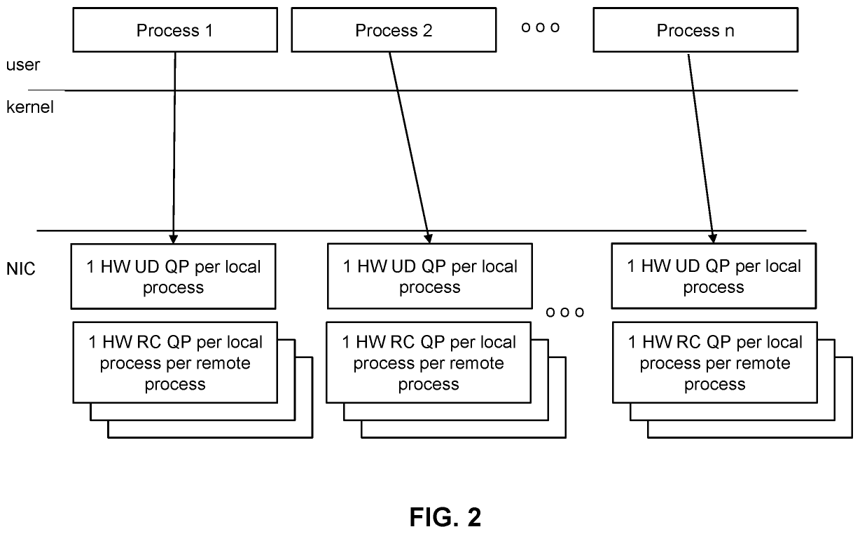

FIG. 2 depicts an example system. In this example, processes Process 1 to Process n can execute in user space and communicate using network interface device with remote processes. In this example, an Unreliable Datagram (UD) QP is allocated for a process and an RC QP is allocated for a local process communicating with remote processes. For example, O(nodes*processes_per_node²) QPs are allocated in this example and memory space allocated for QPs can be substantial.

Workloads such as AI training recommendation engines (e.g., deep learning recommendation model (DLRM)) include all process to all process communication patterns. By allocating more resources to handle communications or attempting to dynamically create resources on network interface device resource, memory and cache resources can be strained. Cache resources may miss more often, introducing latency jitter.

In some examples, to reduce a number QPs used per node and potentially reduce latency of a message to reaching its destination, a local process can send a message to a remote process using a process-to-process connection and/or a rendezvous intermediary module. Selection between the process-to-process connection and rendezvous intermediary module can be made based on factors including one or more of: available memory for message queues, speed of message traversal to the destination, latency of message traversal to the destination, or message size. Load balancing can occur by having more than 1 QP available per remote node per job.

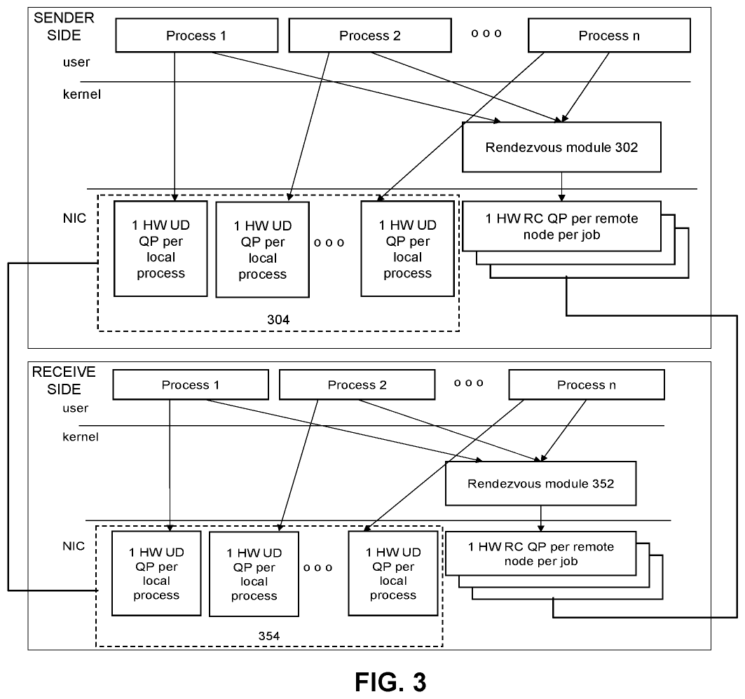

FIG. 3 depicts an example system where a process can utilize process-to-process connection and/or rendezvous intermediary module to copy a communication (e.g., command and data) to a remote node. Rendezvous module can facilitate node-to-node RDMA communications on behalf of local processes within a given parallel job.

In response to the receiver matching an RTS to a local receive request, the receiver can send the CTS with an input output (IO) identifier, rkey, and application buffer address. At CTS, the sender process can request rendezvous module 302 to perform a data transfer in kernel space using reliable transport (RT) with an 10 identifier to the remote buffer identified by the rkey and address. The sender process can register memory allocated for the message (e.g., memory registration (MR)) with rendezvous module 302. A receiver process can register memory allocated for the message with rendezvous module 352 at the receiver. In some examples, the receiver process can be executed on a same processor, same server, or same row as that of the sender server. In some examples, the receiver process can be executed on a different processor, different server, or different row as that of the sender server.

Rendezvous module 302 can initiate a data transfer directly from a sender process' application buffer (using the sender's registered MR) to the receiver's application buffer using the receiver's registered MR as indicated by the rkey and address in the CTS. The transfer can use an RDMA write with immediate, where the immediate data indicates the 10 identifier. Sender process' rendezvous module 302 can perform an RDMA write using a connection oriented transport such as a TCP socket, reliable connection (RC) QP, unreliably connected QP, and so forth.

In some examples, reliable transport can be provided by one or more of a sender process and rendezvous module 352. Rendezvous module 352 can map a job of a process to a single or multiple queue pairs. A sender process can track sequence numbers of transmitted messages and received acknowledgments of receipt of the messages) and/or rendezvous module 352 can maintain a connection with separate sequence numbers and track received acknowledgments of receipt of the messages. In an event of non-receipt of an acknowledgement, a sender process and/or rendezvous module 352 can cause the message to be resent to one or more target processes or nodes.

When the RDMA write finishes, the sender process' rendezvous module 302 can receive a completion indicator and can indicate to the sender process that the send is complete. Receiver's rendezvous module 352 can receive a completion indicator with the immediate data and can use the IO identifier to indicate to the receiving process which IO has completed.

In some examples, O(nodes+processes_per_node) QP resources can be used as opposed to O(nodes*processes_per_node²) of FIG. 2. QP resources can be configured within on-network interface device QP resource caches, and potentially provide consistent latency for end-to-end transmission of messages. Due to a low number of RC QPs needed O(nodes), traffic can be striped or shared among one or more pairs of nodes across one or more QPs, to improve performance and resiliency.

Some examples separate messages into eager and rendezvous categories based on message size. Messages below a threshold size can make use of eager transmission and can be queued to be sent based on a call of MPI_Send. For scalability, eager messages may use a datagram transport such as an Unreliable Datagram (UD) queue pair (QP) within QPs 304 and 354 or UDP socket, such that a sender process and receiver process use a single UD QP to send and receive eager messages. Note that in some examples, rendezvous modules 302 and 352 can permit rendezvous and/or eager messages to be transmitted to one or more target processes or nodes using a datagram transport such as a UD QP within QPs 304 and 354 or UDP socket.

Rendezvous modules 302 and 352 can be implemented using standard Open Fabric Alliance and kernel.org verbs application program interfaces (APIs). Rendezvous modules 302 and 352 can be executed on one or more processors at respective sender and receive network interface devices. As such, network interface devices from multiple different vendors or different network interface devices from a single vendor can utilize rendezvous modules 302 and 352.

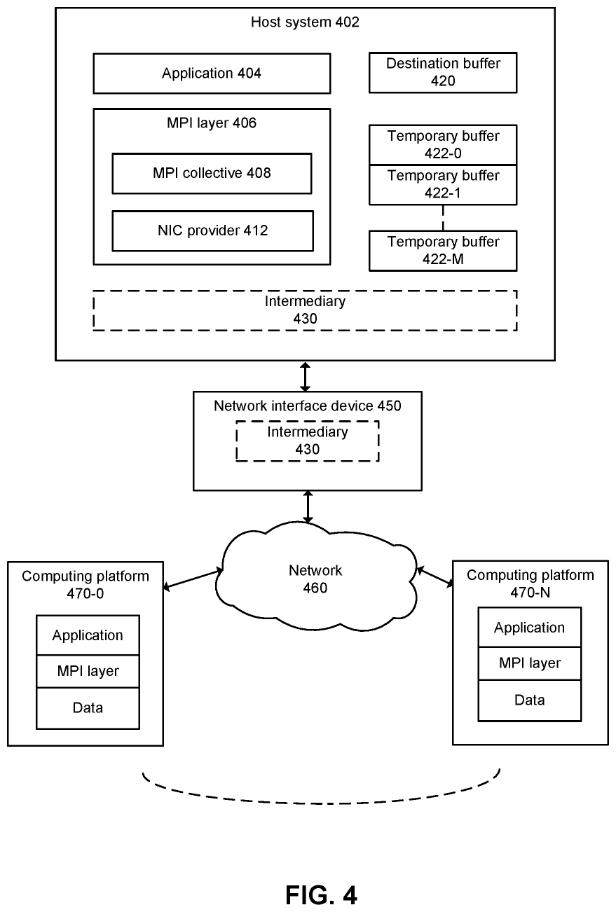

FIG. 4 depicts an example system. For example, the system can be used in a node with a host system computing platform 402 with access to network interface device 450 to transmit and receive packets. For example, the system can be used as part of a data center, server, rack, blade, and so forth. In some examples, the system can execute a process or application as part of a parallel computing environment such as AllReduce or Reduce, or others. The parallel computing environment can attempt to perform training of an AI model or utilize an interface from an AI model. As part of a parallel computing environment, the system can be capable of receiving data from other systems parallel computing environment and sending data to other systems in the parallel computing environment.

For example, host 402 can include one or more processors, accelerators, memory devices, storage devices, persistent memory devices, as well as bus and interconnect technologies to provide communication between the devices. Memory devices can be available as connected to a circuit board in host system 402, as connected to a circuit board in network interface device 450, or as memory accessed through a bus or high speed interface (e.g., PCIe, CXL, or DDR) to host system 402 and network interface device 450. In some examples, one or more processors can execute application 404 that is executed as part of a parallel computing environment such that other instances of the application execute on other computing platforms such as any of platforms 470-0 to 470-N, where N is an integer that is 1 or more. For example, as part of an execution of AllReduce using parallel computation, to perform sharing of vectors with two or more other platforms, application 404 executing on host system 402 can utilize processor executed MPI layer 406 and any of platforms 470-0 to 470-N can also utilize an MPI layer. Other message passing interface layers can be used other than MPI such as Symmetric Hierarchical Memory Access (SHMEM) or Unified Parallel C (UPC).

Application 404 can call MPI collective 408 to initiate an MPI collective computation. Application 404 can identify a vector stored in a register, cache, or memory to MPI collective 408 and identify destination buffer 420 to receive a result of a computation performed by host system 402 or any of platforms 470-0 to 470-N. MPI collective 408 can issue transactions for vectors from a temporary buffer (e.g., send operation) or receive vectors in a temporary buffer (e.g., receiver operation) using MPI two sided 410. Temporary buffers can be allocated in any volatile or non-volatile memory regions and are depicted as temporary buffers 422-0 to 422-M, where M is an integer that is 1 or more.

When a collective job commences, MPI layers on computing platforms can set up temporary buffers for sending and receiving data. Data can include one or more vectors or portions thereof. One or more temporary buffers 422-0 to 422-M can be used to store data or payloads from messages received as part of a parallel computation operation. A user space interface between MPI layer 406 and network interface device 450 can permit MPI layer 406 and application 404 to use transmit or receive operations of network interface device 450. In some examples, network interface device provider 412 can be a kernel space driver or part of an operating system (OS). In other examples, network interface device provider 412 can include a driver that executes in user space.

MPI collective 408 can perform computation on contents of a temporary buffer using a vector and provide a result to destination buffer 420. Content stored in a temporary buffer can be a vector or portion (e.g., subset) of a vector. The MPI API can be used to request a computation, including application supplied functions and predefined functions, such as but not limited to: minimum, maximum, summation, product, logical AND, bit wise AND, logical OR, bit wise OR, logical exclusive OR, bit wise exclusive OR (XOR), and so forth. An application can use the computation as an input to any subsequent computations. An application can use a result from collective computation in the destination buffer 420 to train an AI model or perform inference operations. For example, the application can include a library or component that performs AI operations.

In a similar manner as that described with respect to FIG. 3, in some examples, application 404 can utilize MPI layer 406 can utilize a process-to-process connection and/or intermediary 430 to copy a communication (e.g., command and data) to a remote node. Intermediary 430 can provide RDMA queue pairs for process-to-process communications and RDMA queue pairs shared among processes. Queue pairs for process-to-process communications can provide one queue pair per node, where a node can be a server in a cluster with one or multiple central processing unit (CPU) sockets.

To potentially reduce latency and/or improve resiliency, intermediary 450 may implement more than one RC QP connection to a remote node. Outgoing RDMA writes may be load balanced across the multiple RC QPs. Dispersive routing in a fabric can be utilized via different remote address aliases for different RC QP so that different routes through the fabric can be used. A network interface device can concurrently perform more than one RDMA Write to attempt to cause the network line to be fully utilized, even if one QP experiences a delay due to data or control information fetches across a device interface (e.g., PCIe).

Intermediary 450 can establish one or more RC QP connections to one or more remote nodes and multiplex RDMA Write operations for the processes onto the appropriate RC QP based on which remote node the message is destined-to. To facilitate MR caching, intermediary 450 may implement an MR cache. Due to the use of a shared kernel RC QP, the MRs can be registered in the kernel, providing MR caching as part of MR registration. When part of the kernel, intermediary 450 can use of kernel features, such as the Linux memory management unit (MMU) notifier, so that the MR cache is updated when pages are free by a user process, regardless of what method the process is using to allocate and free pages.

For example, intermediary 430 can be implemented as one or more of: a process in kernel space, a process executed on a processor or by an accelerator in network interface device 450, or a process executed by a hardware 10 accelerator in host 402.

In some examples, queue pairs for process-to-process communications can include UD QP. In some examples, queue pairs for process-to-process communications can used for eager message transfers and/or message transfers for messages that are smaller than a threshold size. Transmissions using UD QP can bypass the kernel and provide low latency transfer techniques, allowing high message rate and low latency. Communications from network interface device 450 to another network interface device can utilize RDMA or other protocols consistent with one or more of: InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE) v2.

A processor or core can execute a process within a virtualized execution environment. In some examples, application 404, MPI layer 406, and network interface device provider 412 can execute within a virtualized execution environment. A virtualized execution environment (VEE) can include at least a virtual machine or a container. VEEs can execute in bare metal (e.g., single tenant) or hosted (e.g., multiple tenants) environments. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can be an OS or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from each other, allowing virtual machines to run Linux®, FreeBSD, VMWare, or Windows® Server operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers are not installed like traditional software programs, which allows them to be isolated from the other software and the operating system itself. Isolation can include permitted access of a region of addressable memory or storage by a particular container but not another container. The isolated nature of containers provides several benefits. First, the software in a container will run the same in different environments. For example, a container that includes PHP and MySQL can run identically on both a Linux computer and a Windows® machine. Second, containers provide added security since the software will not affect the host operating system. While an installed application may alter system settings and modify resources, such as the Windows® registry, a container can only modify settings within the container.

A virtualized infrastructure manager (VIM) or hypervisor (not shown) can manage the life cycle of a VEE (e.g., creation, maintenance, and tear down of VEEs associated with one or more physical resources), track VEE instances, track performance, fault and security of VEE instances and associated physical resources, and expose VEE instances and associated physical resources to other management systems.

Application 404 or VEE can configure or access network interface device 450 using Intel® Scalable I/O Virtualization (SIOV), single-root I/O virtualization (SR-IOV), Multiple Root I/O Virtualization (MR-IOV), or PCIe transactions. For example, network interface device 450 can be presented as a physical function (PF) to any server, application or VEE. In some examples, host system 402 and network interface device 450 can support use of single-root I/O virtualization (SR-IOV). PCI-SIG Single Root 10 Virtualization and Sharing Specification v1.1 and predecessor and successor versions describe use of a single PCIe physical device under a single root port to appear as multiple separate physical devices to a hypervisor or guest operating system. SR-IOV uses physical functions (PFs) and virtual functions (VFs) to manage global functions for the SR-IOV devices. PFs can be PCIe functions that can configure and manage the SR-IOV functionality. For example, a PF can configure or control a PCIe device, and the PF has ability to move data in and out of the PCIe device.

In some examples, host system 402 and network interface device 450 can interact using Multi-Root IOV. Multiple Root I/O Virtualization (MR-IOV) and Sharing Specification, revision 1.0, May 12, 2008, from the PCI Special Interest Group (SIG), is a specification for sharing PCI Express (PCIe) devices among multiple computers.

In some examples, host system 402 and network interface device 450 can support use of Intel® Scalable I/O Virtualization (SIOV). A SIOV capable device can be configured to group its resources into multiple isolated Assignable Device Interfaces (ADIs). Direct Memory Access (DMA) transfers from/to each ADI are tagged with a unique Process Address Space identifier (PASID) number. Unlike the coarse-grained device partitioning approach of SR-IOV to create multiple VFs on a PF, SIOV enables software to flexibly compose virtual devices utilizing the hardware-assists for device sharing at finer granularity. Performance critical operations on the composed virtual device can be mapped directly to the underlying device hardware, while non-critical operations can be emulated through device-specific composition software in the host. A technical specification for SIOV is Intel® Scalable I/O Virtualization Technical Specification, revision 1.0, June 2018.

As is described herein, network interface device 450 can provide network access for transmitting packets to other platforms or receiving packets from other platforms in connection with parallel computation. Network interface device 450 can include various software, devices, and ports that prepare packets for transmission to a network or other medium or process packets received from a network or other medium. In some examples, a network interface device 450 may be embodied as part of a system-on-a-chip (SoC) that includes one or more processors, or included on a multichip package that also contains one or more processors. In some examples, a network interface device 450 can refer to one or more of: a network interface controller (NIC), a remote direct memory access (RDMA)-enabled NIC, SmartNlC, router, switch, forwarding element, infrastructure processing unit (IPU), or data processing unit (DPU).

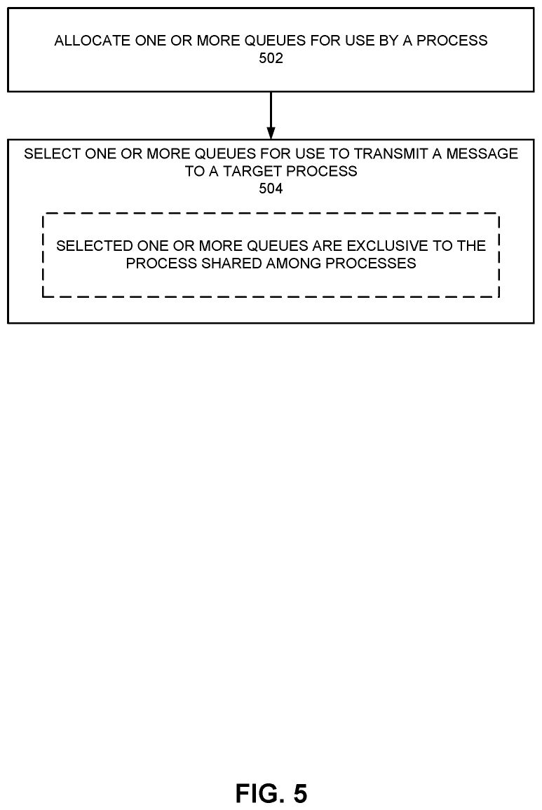

FIG. 5 depicts an example process. The process can be performed by an intermediary or rendezvous module, in some examples. The process can be performed by an intermediary or rendezvous module used by a sender and/or receiver process. The intermediary or rendezvous module can be executed in a process in kernel, hypervisor, or user space, executed on a processor or by an accelerator in network interface device, or executed by a hardware accelerator in a host. At 502, one or more queues can be allocated to a process for use to transmit one or more messages to another process. For example, the intermediary or rendezvous module can allocate one or more RDMA QP. An RDMA QP can be allocated per job in some examples. In some examples, the process can alternatively or in addition, utilize a QP allocated to transmit messages to one or more target processes. At 504, based on a request to transmit a message to another process using the intermediary or rendezvous module, an RDMA QP can be selected for use to transmit the message. The selected RDMA QP can be allocate exclusively for use by the process to transmit messages to one or more target processes or shared among multiple processes to transmit messages to one or more target processes. Thereafter, the message can be transmitted by a network interface device from the selected RDMA QP.

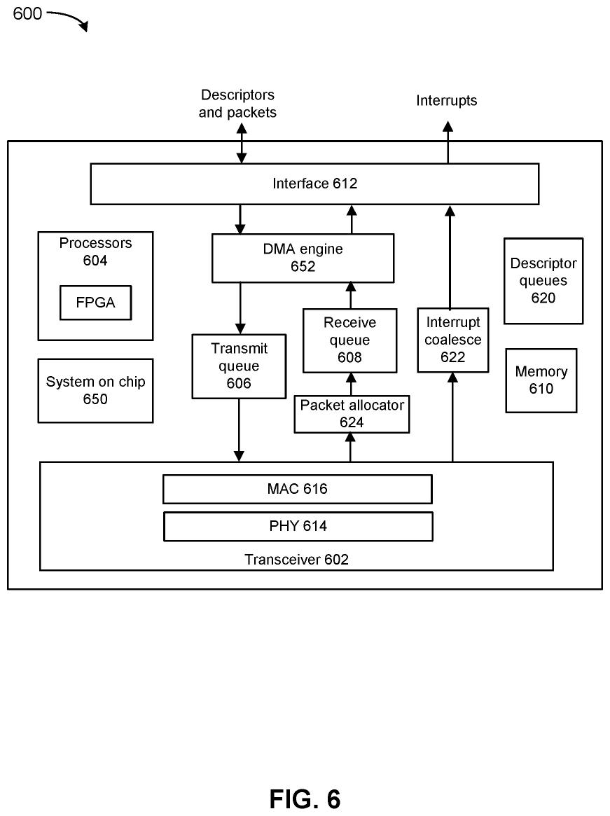

FIG. 6 depicts an example network interface device. The network interface device can include one or more processors or devices to configure and utilize one or more queues to provide communication from one or more processes to one or more remote nodes, as described herein. Network interface 600 can include transceiver 602, processors 604, transmit queue 606, receive queue 608, memory 610, and bus interface 612, and DMA engine 652. Transceiver 602 can be capable of receiving and transmitting packets in conformance with the applicable protocols such as Ethernet as described in IEEE 802.3, although other protocols may be used. Transceiver 602 can receive and transmit packets from and to a network via a network medium (not depicted). Transceiver 602 can include PHY circuitry 614 and media access control (MAC) circuitry 616. PHY circuitry 614 can include encoding and decoding circuitry (not shown) to encode and decode data packets according to applicable physical layer specifications or standards. MAC circuitry 616 can be configured to assemble data to be transmitted into packets, that include destination and source addresses along with network control information and error detection hash values.

Processors 604 can be any a combination of a: processor, core, graphics processing unit (GPU), field programmable gate array (FPGA), application specific integrated circuit (ASIC), or other programmable hardware device that allow programming of network interface 600. For example, a “smart network interface” can provide packet processing capabilities in the network interface using processors 604. Configuration of operation of processors 604, including its data plane, can be programmed using Programming Protocol-independent Packet Processors (P4), C, Python, Broadcom Network Programming Language (NPL), or x86 compatible executable binaries or other executable binaries. Processors 604 and/or system on chip 650 can execute instructions to configure and utilize one or more queues to provide communication from one or more processes to one or more remote nodes using an intermediary, as described herein.

Packet allocator 624 can provide distribution of received packets for processing by multiple CPUs or cores using timeslot allocation described herein or RSS. When packet allocator 624 uses RSS, packet allocator 624 can calculate a hash or make another determination based on contents of a received packet to determine which CPU or core is to process a packet.

Interrupt coalesce 622 can perform interrupt moderation whereby network interface interrupt coalesce 622 waits for multiple packets to arrive, or for a time-out to expire, before generating an interrupt to host system to process received packet(s). Receive Segment Coalescing (RSC) can be performed by network interface 600 whereby portions of incoming packets are combined into segments of a packet. Network interface 600 provides this coalesced packet to an application.

Direct memory access (DMA) engine 652 can copy a packet header, packet payload, and/or descriptor directly from host memory to the network interface or vice versa, instead of copying the packet to an intermediate buffer at the host and then using another copy operation from the intermediate buffer to the destination buffer.

Memory 610 can be any type of volatile or non-volatile memory device and can store any queue or instructions used to program network interface 600. Transmit queue 606 can include data or references to data for transmission by network interface. Receive queue 608 can include data or references to data that was received by network interface from a network. Descriptor queues 620 can include descriptors that reference data or packets in transmit queue 606 or receive queue 608. Bus interface 612 can provide an interface with host device (not depicted). For example, bus interface 612 can be compatible with PCI, PCI Express, PCI-x, Serial ATA, and/or USB compatible interface (although other interconnection standards may be used).

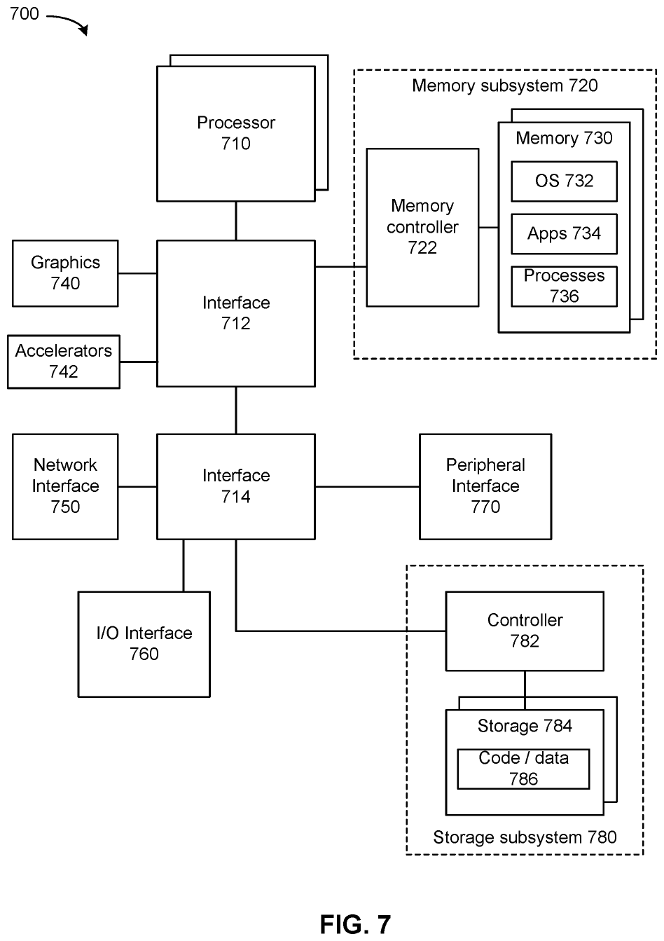

FIG. 7 depicts a system. The system can use embodiments described herein to configure and utilize an intermediary to provide one or more queues to provide communication from one or more processes to one or more remote nodes, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a display that provides an output to a user. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, a driver can configure network interface 750 to perform offloaded operations to configure and utilize an intermediary to provide one or more queues to provide communication from one or more processes to one or more remote nodes, as described herein. In some examples, a driver can enable or disable offload to network interface 750 to configure and utilize an intermediary to provide one or more queues to provide communication from one or more processes to one or more remote nodes, as described herein. A driver can advertise capability of network interface 750 to configure and utilize an intermediary to provide one or more queues to provide communication from one or more processes to one or more remote nodes, as described herein. OS 732 can communicate with a driver to configure and utilize an intermediary to provide one or more queues to provide communication from one or more processes to one or more remote nodes, as described herein. OS 732 can command the driver to configure and utilize an intermediary to provide one or more queues to provide communication from one or more processes to one or more remote nodes, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. Various embodiments can be used in connection with network interface 750, processor 710, and memory subsystem 720.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

In an example, system 700 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

Example 1 includes one or more examples, and includes a computer-readable medium comprising instructions stored thereon, that if executed by one or more processors, cause the one or more processors to: provide a sender process with a capability to select from use of a plurality of connections to at least one target process, wherein the plurality of connections to at least one target process comprise a connection for the sender process and/or one or more connections allocated per job.

Example 2 includes one or more examples, wherein the connection for the sender process comprises a datagram transport for message transfers.

Example 3 includes one or more examples, wherein the one or more connections allocated per job utilize a kernel bypass datagram transport for message transfers.

Example 4 includes one or more examples, wherein the one or more connections allocated per job comprise a connection oriented transport and wherein multiple remote direct memory access (RDMA) write operations for a plurality of processes are to be multiplexed using the connection oriented transport.

Example 5 includes one or more examples, wherein the one or more connections allocated per job load balance message transmission for multiple processes over one or more connections.

Example 6 includes one or more examples, wherein selection from use of a plurality of connections to at least one target process is based on one or more of: available memory for message queues, speed of message traversal to a destination, latency of message traversal to the destination, or message size.

Example 7 includes one or more examples, wherein an intermediary or sender process is to select from use of a plurality of connections to at least one target process, wherein the plurality of connections to at least one target process comprise a connection for the sender process and/or one or more connections allocated per job and wherein the intermediary is to comprise one or more of: a process executing in kernel space on a processor, a process executing on an accelerator in a network interface device, or a process executing on a hardware accelerator in a host.

Example 8 includes one or more examples, wherein the sender process is to perform an application based on Message Passing Interface (MPI).

Example 9 includes one or more examples, and includes a method comprising: a plurality of processes utilizing an intermediary for transfers of messages, wherein the intermediary establishes at least one connection oriented transport to at least one remote node and provides message transfers for a plurality of processes over at least one of the at least one connection oriented transport to the at least one remote node.

Example 10 includes one or more examples, wherein the at least one connection oriented transport is consistent with one or more of: InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE) v2.

Example 11 includes one or more examples, and includes providing reliable transport over the at least one connection oriented transport in addition to reliable transport provided by a sender process.

Example 12 includes one or more examples, wherein: at least one process of the plurality of processes utilizes a datagram transport for message transfers.

Example 13 includes one or more examples, wherein: at least one connection oriented transport to at least one remote node utilizes a Reliable Connection (RC) queue pair (QP) for message transfers.

Example 14 includes one or more examples, wherein queue resources of the at least one connection oriented transport are configured within an on-network interface device memory or cache.

Example 15 includes one or more examples, and includes a network interface device comprising circuitry configured to: provide a sender process with a capability to select from use of a plurality of connections to at least one target process, wherein the plurality of connections to at least one target process comprise a connection for the sender process and/or one or more connections allocated per job.

Example 16 includes one or more examples, wherein the connection for the sender process comprises a datagram transport for message transfers.

Example 17 includes one or more examples, wherein the one or more connections allocated per job comprise a connection oriented transport and wherein multiple remote direct memory access (RDMA) write and/or read operations for a plurality of processes are to be multiplexed using the connection oriented transport.

Example 18 includes one or more examples, wherein selection from use of a plurality of connections to at least one target process is based on one or more of: available memory for message queues, speed of message traversal to a destination, latency of message traversal to the destination, or message size.

Example 19 includes one or more examples, wherein an intermediary or sender process is to select from use of a plurality of connections to at least one target process, wherein the plurality of connections to at least one target process comprise a connection for the sender process and/or one or more connections allocated per job and wherein the intermediary is to comprise one or more of: a process executing in kernel space on a processor, a process executing on an accelerator in a network interface device, or a process executing on a hardware accelerator in a host.

Example 20 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), or data processing unit (DPU).

What is claimed is:

1. A computer-readable medium comprising instructions stored thereon, that if executed by one or more processors, cause the one or more processors to:
provide a sender process with a capability to select from use of a plurality of connections to at least one target process, wherein the plurality of connections to at least one target process comprise a connection for the sender process and/or one or more connections allocated per job.

2. The computer-readable medium of claim 1, wherein the connection for the sender process comprises a datagram transport for message transfers.

3. The computer-readable medium of claim 1, wherein the one or more connections allocated per job utilize a kernel bypass datagram transport for message transfers.

4. The computer-readable medium of claim 1, wherein the one or more connections allocated per job comprise a connection oriented transport and wherein multiple remote direct memory access (RDMA) write operations for a plurality of processes are to be multiplexed using the connection oriented transport.

5. The computer-readable medium of claim 1, wherein the one or more connections allocated per job load balance message transmission for multiple processes over one or more connections.

6. The computer-readable medium of claim 1, wherein selection from use of a plurality of connections to at least one target process is based on one or more of: available memory for message queues, speed of message traversal to a destination, latency of message traversal to the destination, or message size.

7. The computer-readable medium of claim 1, wherein an intermediary or sender process is to select from use of a plurality of connections to at least one target process, wherein the plurality of connections to at least one target process comprise a connection for the sender process and/or one or more connections allocated per job and wherein the intermediary is to comprise one or more of: a process executing in kernel space on a processor, a process executing on an accelerator in a network interface device, or a process executing on a hardware accelerator in a host.

8. The computer-readable medium of claim 1, wherein the sender process is to perform an application based on Message Passing Interface (MPI).

9. A method comprising:
a plurality of processes utilizing an intermediary for transfers of messages, wherein the intermediary establishes at least one connection oriented transport to at least one remote node and provides message transfers for a plurality of processes over at least one of the at least one connection oriented transport to the at least one remote node.

10. The method of claim 9, wherein the at least one connection oriented transport is consistent with one or more of: InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE) v2.

11. The method of claim 9, comprising:
providing reliable transport over the at least one connection oriented transport in addition to reliable transport provided by a sender process.

12. The method of claim 9, wherein:
at least one process of the plurality of processes utilizes a datagram transport for message transfers.

13. The method of claim 9, wherein:
at least one connection oriented transport to at least one remote node utilizes a Reliable Connection (RC) queue pair (QP) for message transfers.

14. The method of claim 9, wherein queue resources of the at least one connection oriented transport are configured within an on-network interface device memory or cache.

15. An apparatus comprising:
a network interface device comprising circuitry configured to:
provide a sender process with a capability to select from use of a plurality of connections to at least one target process, wherein the plurality of connections to at least one target process comprise a connection for the sender process and/or one or more connections allocated per job.

16. The apparatus of claim 15, wherein the connection for the sender process comprises a datagram transport for message transfers.

17. The apparatus of claim 15, wherein the one or more connections allocated per job comprise a connection oriented transport and wherein multiple remote direct memory access (RDMA) write and/or read operations for a plurality of processes are to be multiplexed using the connection oriented transport.

18. The apparatus of claim 15, wherein selection from use of a plurality of connections to at least one target process is based on one or more of: available memory for message queues, speed of message traversal to a destination, latency of message traversal to the destination, or message size.

19. The apparatus of claim 15, wherein an intermediary or sender process is to select from use of a plurality of connections to at least one target process, wherein the plurality of connections to at least one target process comprise a connection for the sender process and/or one or more connections allocated per job and wherein the intermediary is to comprise one or more of: a process executing in kernel space on a processor, a process executing on an accelerator in a network interface device, or a process executing on a hardware accelerator in a host.

20. The apparatus of claim 15, wherein the network interface device comprises one or more of: a network interface controller (NIC), a remote direct memory access (RDMA)-enabled NIC, SmartNlC, router, switch, forwarding element, infrastructure processing unit (IPU), or data processing unit (DPU).
